(19) United States
(12) Patent Application Publication
(10) Pub. No.: US 2017/0350494 A1
(43) Pub. Date: Dec. 7, 2017

(54) STEPPED JOINT OF A PART ON A TRANSMISSION HOUSING

(71) Applicant: Siemens Aktiengesellschaft, Munich (DE)

(72) Inventor: Jan Weule, Duisburg (DE)

(73) Assignee: Siemens Aktiengesellschaft, Munich (DE)

(21) Appl. No.: 15/517,780

(22) PCT Filed: Oct. 8, 2015
(86) PCT No.: PCT/EP2015/073254

§ 371 Date: Apr. 7, 2017

(30) Foreign Application Priority Data
Oct. 21, 2014 (DE) 10 2014 221 339.8

(51) Int. Cl. F16H 57/029; F16H 57/021; F16H 57/031; F16H 57/02; F16J 15/06; F04D 13/12; F04D 25/16; F16J 15/04; F01D 15/12

(52) U.S. Cl. CPC F16H 57/029; F16H 57/031; F16H 57/021; F16H 2057/02069; F01D 15/12; F04D 13/12; F04D 25/163; F16J 15/04; F16J 15/06

(57) ABSTRACT

A separable housing for a transmission wherein the transmission that is to be received in the separable housing has a gear shaft and at least two pinion shafts which are engaged with a gear that is arranged on the gear shaft. The separable housing has at least one first housing element and a second housing element that is connected to the first housing element by a joint of a part. The gear shaft and the at least two pinion shafts can be received in the joint of a part in receptacles on the housing. The joint of a part has a first part-joint stepped section and a second part-joint stepped section, each stepped section forming a different horizontal level in the joint of a part and each stepped section being formed between two of the receptacles of two of the shafts, the stepped sections also being complementarily formed.

### CROSS REFERENCE TO RELATED APPLICATIONS

This application is the US National Stage of International Application No. PCT/EP2015/073254 filed Oct. 8, 2015, and claims the benefit thereof. The International Application claims the benefit of German Application No. DE 102014221339.8 filed Oct. 21, 2014. All of the applications are incorporated by reference herein in their entirety.

### FIELD OF INVENTION

The invention relates to a divisible housing for a gearing, in particular for a gearing of a fluid machine such as for example a geared turbocompressor, and to a fluid machine having a divisible housing of said type.

### BACKGROUND OF INVENTION

Compressors or fluid-compressing devices are utilized in various sectors of industry for various applications which involve a compression of fluids, specifically (process) gases. Known examples of this are turbocompressors in mobile industrial applications such as in exhaust-gas turbochargers or in jet engines, or else in static industrial applications such as geared compressors or geared turbocompressors for air separation.

In the case of such a turbocompressor—which, in terms of its mode of operation, operates continuously—the pressure increase (compression) of the fluid is effected by virtue of an angular momentum of the fluid from inlet to outlet being increased by means of a rotating impeller, which has radially extending blades, of the turbocompressor, by way of the rotation of the blades. Here, that is to say in a compressor stage of said type, the pressure and temperature of the fluid increase, whereas the relative (flow) speed of the fluid decreases in the impeller or turbo impeller. To realize the greatest possible pressure increase or compression of the fluid, it is possible for multiple such compressor stages to be connected in series.

As structural forms of turbocompressors, a distinction is made between radial and axial compressors.

In the case of the axial compressor, the fluid to be compressed, for example a process gas, flows through the compressor in a direction parallel to the axis (axial direction). In the case of the radial compressor, the gas flows axially into the impeller of the compressor stage and is then diverted outward (radially, radial direction). In the case of multi-stage radial compressors, a flow deflection is thus required downstream of each stage.

Combined types of axial and radial compressors, by means of their axial stages, draw in large volume flows, which are compressed to high pressures in the subsequent radial stages.

Whereas use is normally made of single-shaft machines, it is the case in (multi-stage) geared turbocompressors (hereinafter also referred to for short merely as geared compressors) that the individual compressor stages are grouped around a large gear/pinion (hereinafter referred to merely as large gear) arranged on a (large-gear) shaft, wherein multiple parallel (pinion) shafts which bear in each case one or two impellers (turbo impellers arranged on free shaft ends of the pinion shafts)—which are received in spiral housings realized as housing attachments—are driven by a large drive toothed gear/pinion mounted in the housing, the large gear.

A geared compressor of said type, a geared compressor from the company Siemens with the designation STC-GC, used for air separation, is known from http://www.energy.siemens.com/hq/de/verdichtung-expansion-ventilation/turboverdichter/getriebeturboverdichter/stc-gc.htm (as available on Sep. 10, 2014).

In the case of a geared compressor, the drive, and thus a gearing of power from the large gear to the shafts or pinion shafts, are realized by means of inter-engaging or intermeshing toothings on the large gear and pinion shaft. By means of different numbers of teeth of the toothings or different pitch circle diameters, desired gearing actions or gearing ratios (power stages) are realized in the individual gearing stages. That is to say, the individual pinion shafts are coupled in terms of toothing geometry and pinion shaft central position (central point or axis of rotation of a pinion shaft) to the large gear and to one another.

In the case of multiple pinion shafts being arranged around the large gear, a compromise must be found between ideal and practicable gearing ratios.

A significantly determining and limiting variable is in this case the available and/or practicable structural space, in particular the space outside the housing—as housing attachments—that is arranged at the pinion shaft ends and available for flow-guiding components (spiral housings).

The coupling of the pinion shafts to the large gear by means of toothing geometry and pinion shaft central position thus takes on major importance in the development and configuration and design and construction of geared turbomachines. Owing to the proportions or size differences, that is to say owing to the large gear which is very much larger than the often relatively small pinion shafts for arrangement around the large gear, it is in particular the case that the question arises as to where the pinion shafts or the pinion shaft central positions thereof should be situated.

In a conventional arrangement, two pinion shafts are situated in a first, undivided and horizontal parting joint with the large gear or the large-gear shaft thereof. That is to say, all three shafts lie in/at one ((common) horizontal) plane/level. A third pinion shaft is arranged above the large gear in a second, undivided and horizontal parting joint.

This arrangement results in six free shaft ends at the total of three pinion shafts, which shaft ends—equipped with turbo impellers—make it possible to realize a multi-stage geared turbomachine with six possible process stages.

To increase a compression power of a six-stage geared compressor of said type, it is known for the number of process stages to be increased, for example by means of a fourth pinion shaft (with then eight stages in the geared turbocompressor).

Here, it is sought for said fourth pinion shaft to be accommodated in the housing of the geared compressor economically and with manageable outlay in terms of design and assembly.

Two approaches for the arrangement of such a fourth pinion shaft are known:

a) arrangement of the fourth pinion shaft above the large gear together with the third pinion shaft in the second, undivided and horizontal second parting joint.

In the case of the fourth pinion shaft being arranged above the large gear, the available structural space must be shared with the third pinion shaft. For the arrangement of the third and of the fourth pinion shaft in the parting joint, collisions of externally arranged flow-guiding components (spiral housing) are of significance. To be able to define interfaces in relation to adjacent functions (bearing receptacle, spiral connection), the parting joint is of undivided and horizontal form. That is to say, the third and the fourth pinion shaft lie in/at one ((common) horizontal) plane/level.

In order, in the case of such an arrangement, to realize different gearing ratios in the gearing stages, it is known for a large gear with multiple toothings, for example as an integrated unit with a second large gear, to be used. That is to say, such a large gear with multiple toothings has (axially) staggered toothings which mesh in each case with different pinion shafts.

In this way, although a multiplicity of additional gearing ratios and pinion shaft central positions coupled thereto are possible, this is associated with high manufacturing and cost outlay.

b) Arrangement of the fourth pinion shaft below the large gear in an embodiment as a plug-in pinion shaft.

In the case of an arrangement of the fourth pinion shaft below the large gear, the structural space does not need to be shared with an adjacent pinion shaft, but no parting joint is provided there which can be utilized for installation purposes.

The installation of the fourth pinion shaft is possible only by way of a lateral insertion (plugging-in) action (plug-in pinion shaft).

In this way, the pinion shaft central positions can be virtually freely selected taking into consideration the spiral housing of the first parting joint. However, in this case, too, the realization is associated with considerable additional outlay (assembly parts, assembly process) and correspondingly high costs.

There is thus a demand for a housing for a gearing, in particular of a geared compressor of said type, which makes it possible to realize different gearing ratios of the gearing with little manufacturing and cost outlay, which can be realized in a structural-space-optimized, simple and inexpensive manner, and which can also be assembled in a simple and inexpensive manner.

In this regard, DE 10 2011 003 525 A1 has disclosed an eight-stage geared compressor having a divisible housing and having a gearing received in the divisible housing, having a large gear arranged on a (large-gear) shaft and having a total of four pinion shafts in engagement with the large gear.

The divisible housing from DE 10 2011 003 525 A1 has three housing elements arranged one above the other, that is to say a cover, an upper case and a lower case, wherein a lower (first) parting joint is formed between the lower case and the upper case and an upper (second) parting joint is formed between the cover and the upper case.

The upper (second) parting joint (between cover and upper case) has a parting-joint offset in the form of a vertical step, which forms two different horizontal levels in the upper (second) parting joint; the lower (first) parting joint is of non-stepped form and runs horizontally.

DE 10 2011 003 525 A1 then furthermore provides that, in the lower, non-stepped, horizontal (first) parting joint, the (large-gear) shaft and two of the four pinion shafts (to both sides of the large-gear shaft) are received (in/at a common horizontal plane/level). In the upper, stepped (second) parting joint, the other two pinion shafts are received, to both sides of the parting-joint offset, at the two different horizontal levels.

DE 909 853 B has furthermore disclosed a multi-stage rotary compressor with plug-in pinion shafts situated at the top and at the bottom.

### SUMMARY OF INVENTION

The invention is based on the object of specifying a housing for a gearing, in particular for a gearing of a geared compressor, which improves the disadvantages from the prior art, in particular makes it possible to realize different gearing ratios of the gearing with little manufacturing and cost outlay, can be realized in a structural-space-optimized, simple and inexpensive manner, and can also be assembled in a simple and inexpensive manner.

The object is achieved by means of a divisible housing for a gearing, in particular for a gearing of a fluid machine, for example of a geared turbocompressor, and by means of a fluid machine having a divisible housing of said type, having the features of the respective independent patent claim.

The divisible housing comprises at least one first housing element and one second housing element which is connected to the first housing element via a parting joint, for example a (housing) lower case and a (housing) upper case.

The gearing to be provided for being received in the divisible housing has a large-gear shaft with at least two pinion shafts which are in engagement with a large gear arranged on the large-gear shaft.

Here, “in engagement” may mean that the large gear and the pinion shafts have inter-engaging or intermeshing toothings. For example, the toothing may be in the form of a straight or helical or arcuate toothing.

According to the invention, the parting joint is formed such that the large-gear shaft and the at least two pinion shafts can be received in receptacles, for example bearing receptacles or bearing shells, on the housing elements in the parting joint.

It is furthermore provided that the parting joint has a first parting-joint offset and a second parting-joint offset (for short, in simplified and illustrative terms, a “twofold or double parting-joint offset”), which form in each case two different horizontal levels in the parting joint and which are arranged in each case between two of the receptacles of two of the shafts, for example between the receptacles for the large-gear shaft and a (left-hand) pinion shaft arranged to the left of the large-gear shaft (first parting-joint offset) or between the receptacles for the large-gear shaft and a (right-hand) pinion shaft arranged to the right of the large-gear shaft (second parting-joint offset).

It is furthermore provided that the first and the second parting-joint offset are of complementary form with respect to one another. Expressed in illustrative and simplified terms, the parting joint in this case has a (central) elevated plane—flanked by two lowered planes—(upturned U-shaped profile of the parting joint), or the parting joint has in this case a (central) lowered plane—flanked by two elevated planes (U-shaped profile of the parting joint).

Here, a parting joint offset is to be understood to mean that the parting joint forms two different horizontal levels to both sides of a transition point which forms the first or second parting-joint offset respectively. The height difference (offset height) that can thus be realized by means of the first and second parting-joint offsets within the parting joint may assume any desired value within broad ranges, for example 10 mm to 1000 mm or 20 mm to 500 mm, advantageously 30 mm to 100 mm, in particular 60 mm. A limitation is posed at most by the size of the large gear, the size of the pinion shafts and/or by possible resulting collisions with attachment parts.

Said different levels to both sides of the first and second parting-joint offset in the parting joint, or said first or second parting-joint offset, may advantageously be realized by virtue of the first and the second housing element having in each case one mutually corresponding step which forms the first or second parting-joint offset respectively—or else multiple steps, for example in the manner of a staircase (“doubly stepped parting joint”).

It is also possible for the different levels, or for the parting-joint offset, to be realized by means of transition points of other design or form, such as inclined, rectilinearly rising or falling and/or curved or rounded profiles in the two corresponding housing elements.

The “double parting-joint offset” according to the invention in the parting joint thus makes it possible for (at least) three different horizontal planes to be formed in the parting joint, which planes can be utilized in each case for mounting of one of the shafts, that is to say of the large-gear shaft and of the at least two pinion shafts in engagement with the large gear, at different horizontal levels or in different horizontal planes in a single parting joint.

That is to say, by means of the degrees of (design) freedom thus obtained or generated with regard to the parting joint, it is the case—in the corresponding receptacles on the housing elements—that the at least two pinion shafts no longer need to be arranged in one plane with respect to one another and with respect to the large-gear shaft, and said pinion shafts, or the shaft axes thereof, can be arranged (distributed between the three different levels/planes) in such a way that structural space can be realized between (externally arranged) flow-guiding components such as spiral housings.

In this way, structural space between the flow-guiding components and/or the spiral housings can be optimally distributed, which simplifies configuration and/or assembly of the divisible housing. Aside from an improvement in the case of a fluid machine which utilizes a housing of said type, it is thus also the case that a number of possible variants in this regard in a planning phase is increased.

If the at least two pinion shafts are arranged in the different planes/levels (generated by the parting-joint offsets) in the parting joint and so as to be in engagement with the large gear, this permits the arrangement of the at least two pinion shafts in a single parting joint with simultaneously different pinion shaft central positions. The pitch circles of the at least two pinion shafts must merely contact the pitch circle of the large gear (which is possible at any desired different heights owing to the parting-joint offsets); the previous requirement for the pinion shaft central points of the at least two pinion shafts which are in engagement with the large gear to lie in the same horizontal plane (undivided and horizontal parting joint) can be eliminated.

The receiving of the at least two pinion shafts in a single parting joint is thus also advantageous for cost and assembly reasons, and is further utilized by means of the parting-joint offsets; by means of the different pinion shaft central positions that can be realized, it is possible—owing to the thus expanded structural space possibilities—to realize different gearing ratios (variability of the gearing ratios)—for example without outlay for a multiple toothing on the large gear—in the gearing. In simplified terms, the invention thus makes it possible to realize the additional degrees of (design) freedom in the design process, which can be utilized for the realization of different gearing ratios.

In the case of the fluid machine according to the invention, for example a turbine, a turbocompressor, a multi-stage geared compressor or a pump, said divisible housing is provided. In the divisible housing, there is then received a gearing with a large-gear shaft and with at least two pinion shafts which are in engagement with a large gear arranged on the large-gear shaft, for example to both sides of the large-gear shaft, wherein the at least two pinion shafts and the large-gear shaft are received in the receptacles on the housing elements in the parting joint.

To be in engagement with the large gear, the pitch circles of the two pinion shafts contact the pitch circle of the large gear—albeit at different horizontal heights, that is to say the pinion shaft central positions lie in/at different horizontal planes/levels—owing to the first and the second parting-joint offset.

At least one axis (of rotation) of the two axes (of rotation) of the at least two pinion shafts may in this case be arranged below an axis (of rotation) of the large-gear shaft in the divisible housing. In particular, both axes (of rotation) of the at least two pinion shafts may be arranged below the axis (of rotation) of the large-gear shaft. In this way, it is thus the case that more structural space is available above the axis (of rotation) of the large-gear shaft in the divisible housing, for example for further pinion shafts which are in engagement with the large gear—or with a further large gear, in particular one which is coupled to or in engagement with the abovementioned large gear.

The advantages of the housing according to the invention are thus obtained correspondingly for the fluid machine according to the invention.

Refinements of the invention will also emerge from the dependent claims and relate to the divisible housing and to the fluid machine.

In a particular refinement, it is provided that the first and/or the second parting-joint offset are/is in the form, or in each case in the form, of a rectilinearly running vertical step. In other words, the first and the second housing element have in each case one mutually corresponding vertical step which forms the first and/or the second parting-joint offset.

Such steps in the housing elements may for example be cast in by way of corresponding casting processes with steel and/or may be (finish-)machined in steel parts.

In a refinement, it may also be provided that a height difference formed by one of the parting-joint offsets (also referred to for short merely as offset height) of the two different horizontal levels as defined in a manner dependent on dimensions of the shafts and/or pinions arranged on the shafts and/or in a manner dependent on a structural space requirement.

It may also be provided in a refinement—in particular in the case of two parting-joint offsets of complementary form—that the offset heights of the first and of the second parting-joint offsets are equal or substantially equal.

In a further refinement, it is provided that the receptacles for the two pinion shafts are arranged to both sides of the receptacle for the large-gear shaft on the housing elements in the parting joint (on the three different planes/levels formed by the parting-joint offsets). Considered illustratively, the pinion shaft receptacles do not lie (no longer lie) in the plane of the large-gear shaft receptacle.

If it is then also provided here, in a refinement, that the parting-joint offsets are of complementary form—for example with an upturned U-shaped profile—it is thus possible for the pinion shaft receptacles (and thus also the pinion shafts) to “migrate” downward in the parting joint (relative to the large-gear shaft receptacle or the large-gear shaft), whereby structural space can be obtained above this, for example in an upper, further parting joint.

In said further—possibly also (singly or multiply) stepped or else non-stepped—parting joint, it is then possible for multiple receptacles for further pinion shafts to be provided. In this way, a pinion shaft—otherwise provided as a plug-in pinion shaft—can be “displaced” in said further parting joint, whereby a cumbersome plug-in pinion shaft arrangement can be omitted.

Accessibility to and installation of pinion shafts received in the parting joints is also simplified in relation to plug-in pinion shafts (which must be plugged in from the outside in a cumbersome manner).

In one refinement, it may be provided that the first and/or second parting-joint offset is (in each case) sealed off using a sealing element which has a form corresponding substantially to the (respective) parting-joint offset.

That is to say, the (respective) sealing element is adapted in terms of its shape substantially to the (respective) parting-joint offset. Said sealing element, in terms of its shape, substantially follows the (respective) parting-joint offset profile, or follows the profile of the parting joint in the region of the (respective) parting-joint offset/at the (respective) transition point.

Here, “substantially corresponding in terms of shape” may mean that the sealing element may have small or narrow edge zones which extend beyond the shape of the parting-joint offset but which are of lesser significance in relation to the shape of the parting-joint offset, for example narrow edge regions provided for a screw connection to the housing and/or to the housing elements.

That is to say, an outer diameter of the sealing element is slightly larger than the shape of the parting-joint offset.

Expressed in simplified terms and, for example, illustratively, if the (respective) parting-joint offset is for example formed as a step which runs rectilinearly vertically or so as to be inclined relative to the vertical, then the sealing element which seals off the (or said) parting-joint offset may—correspondingly to the straight vertical or straight inclined profile of the (respective) parting-joint offset—be of rod-shaped or bar-shaped form (“sealing bar”).

Alternatively, if the (respective) parting-joint offset is for example of arcuate form, then the sealing element which seals off the (or said) parting-joint offset may be of correspondingly curved form—corresponding to the curved profile of the parting-joint offset.

Such a design of the sealing element is based on the consideration and realization that the shape of the sealing element, in particular the outer dimension thereof, influences or limits the possible minimum spacing of the shafts which are arranged in the parting joint to both sides of the (respective) parting-joint offset or of the flow-guiding components (spiral housings) arranged on the shaft ends of said shafts—and thus correspondingly the housing or the buildability and flexibility thereof in terms of practicable gearing ratios.

However, if the shape of the outer dimension of the sealing element thus substantially corresponds to the shape of the (respective) parting-joint offset, then the (horizontal) minimum spacing that must be maintained—at the respective parting-joint offset heights—between the shafts or the flow-guiding components (spiral housings) arranged on the shaft ends thereof is minimized.

Even large vertical parting-joint offsets or vertical steps, or vertical parting-joint offsets or vertical steps of virtually any desired size, can thus be realized in parting joints in divisible gearing housings. The number of geared compressors or fluid machines that can be built with such housings is increased; more gearing ratios in such gearings can be realized.

Furthermore, for efficient and long-term operation of the gearing to be accommodated in the divisible housing, the seal, in particular an oil seal for example in the case of oil sump lubrication realized in the housing, of the parting joint is also of major significance, which can be realized in a simple, inexpensive and efficient manner specifically by means of the sealing element according to the invention.

The sealing element discussed here can thus, correspondingly to a straight vertical profile, which is provided in a refinement, of the first and/or second parting-joint offset, be of rod-shaped or bar-shaped form (“sealing bar”). A sealing bar of said type is of extremely compact construction in a horizontal direction—if, correspondingly to the first or second parting-joint offset formed as a step, said sealing bar is arranged vertically (so as to seal off the parting-joint offset), whereby the structural space requirement in said direction is as small as possible.

In another refinement, it is provided that the sealing element is composed of metal, in particular of aluminum.

Furthermore, in one refinement, it may be provided that the sealing element is arranged over the first and/or second parting-joint offset, in particular in a manner screwed to the housing elements and/or recessed in the first and/or second parting-joint offset.

The production of a sealing element seat on the gearing housing or parting-joint offset is advantageously performed during the spindling-out of the receptacles or bearing seats (for the pinion shafts) and does not necessitate a further machining step. Owing to the recessed arrangement of the sealing element, the latter does not pose an obstruction to adjacent components; a device for spiral setting can still be mounted.

In a particular refinement, it is provided that the sealing element is arranged so as to completely cover the first and/or second parting-joint offset.

In another refinement, it is provided that the sealing element has at least one recess which is open on one side (open screw seat), using which recess said sealing element can be screwed to one of the housing elements.

In a particularly advantageous refinement, it is provided that the sealing element has two recesses (two open screw seats) which are in each case open on one side and using which the sealing element can be screwed to the housing elements. Here, it is furthermore also particularly advantageous for the two open screw seats to be arranged on opposite ends of the sealing element.

For example, if the first and/or second parting-joint offset is formed as a vertical step in the parting joint between the two housing elements and is sealed off by means of the—correspondingly vertically installed—sealing bar, which at its (opposite) sealing bar ends has said two open screw seats (for the installation screws for the screw connection to the upper and lower housing elements), then damage during a dismounting process of a housing element in the case of a sealing bar still inadvertently being mounted can be prevented.

Furthermore, if for example—but not imperatively—the housing is subject to an internal pressure, it is also possible for multiple screw connections to be provided, for example (possibly in encircling fashion) in the edge region of the sealing element or sealing bar and/or in addition to the screw connections by means of the two open screw seats on the ends of the sealing element, for the sealing element or sealing bar with the housing elements.

Furthermore, in one refinement, it may also be provided that a sealing means, in particular an O-ring (or else multiple O-rings) or a round cord, is arranged on the sealing element.

For this purpose, the sealing element may have a groove or a projection into which the sealing element is placed or on which the sealing element is arranged. That is to say, it is for example possible for the O-ring (or the O-rings) to be mounted onto the projection, or for example for the round cord to be wound around the projection, or for example for the O-ring to be laid into the groove.

If, as is provided in a particular refinement, the sealing element which has said sealing means lies axially in axial receptacles (“sealing element seat”) formed on the housing elements in the region of the parting-joint offset, or is for example screwed axially to the housing/to the housing elements, then the sealing means in this case imparts an axial sealing action, whereby a fit for the centering of the sealing element in the housing can be omitted.

Said sealing element with said (axially laid-on) sealing means furthermore has the advantage that the sealing direction acts counter to the clamping force of the part screw connection. Also, regardless of the sealing means arrangement on the sealing element, the design and assembly of the parting-joint screw connection remain unaffected.

In a further refinement, it is provided that stiffening means or stiffening elements, such as for example struts or the like, are arranged on the housing elements—in particular so as to be arranged in stellate fashion around a shaft receptacle. A weakening of the housing can be compensated for in this way.

Furthermore, it may be provided that the divisible housing has a third housing element which is connected to the first housing element or to the second housing element via a further parting joint. Said further parting joint may have one or else multiple parting-joint offsets, that is to say in particular may be of singly or multiply stepped configuration; the further parting joint may however also be formed without a parting-joint offset/offsets or so as to be of non-stepped form.

It may also be provided that further housing attachments are mounted on the divisible housing, for example externally arranged flow-guiding components such as spiral housings and/or spiral connections.

In a particular refinement, it is provided that the first and the second housing element are a lower case and an upper case of the gearing housing; if a third housing element is provided, this may be a (housing) cover of the gearing housing.

In one refinement, it may also be provided that the first and the second housing element are aligned and/or centered relative to one another by means of vertically mutually staggered step surfaces of steps which form the parting-joint offsets.

This may correspondingly also be provided for a third housing element with stepped further parting joint.

In another refinement, it is provided that the first and the second housing element are pinned to one another and/or are screwed to one another. Here, too, this may correspondingly also be provided for a third housing element. The housing elements may be composed of metal, in particular steel.

In a further refinement, it is provided that the gearing has at least two further pinion shafts which are in engagement with the large gear or with a further large gear, for example for a (gearing) housing for an eight-stage geared compressor.

Here, it is advantageous for the at least two further pinion shafts to be arranged in receptacles on the second housing element and on the third housing element (which is then to be provided), for example an upper case and a cover, in which further, in particular non-stepped parting joints (which are then present) are arranged.

Expressed in simplified terms and illustratively, if the divisible housing is to be suitable for an eight-stage geared compressor (with four pinion shafts and one large-gear shaft), then three shaft receptacles are provided in the doubly stepped parting joint (there, in/at the three different planes/levels formed by the parting-joint offsets) between lower case and upper case, that is to say two pinion-shaft receptacles arranged to both sides of the receptacle for the large-gear shaft, and two pinion-shaft receptacles in the (possibly also stepped) further parting joint between upper case and cover.

In a further refinement—in particular in the case of a three-part housing, which has the parting joint and the further parting joint, for an eight-stage gearing with one large-gear shaft and four pinion shafts—it is provided that the parting-joint offsets are formed in the parting joint, and the further parting joint is formed as a further, non-stepped parting joint, such that the receptacles, arranged on the housing elements in the parting joints, of the at least two and of the at least two further pinion shafts form a trapezoid, in particular that the receptacles of the at least two pinion shafts and the receptacles of the at least two further pinion shafts each form base sides of the trapezoid.

Expressed illustratively, connecting lines between the pinion shaft receptacles or between pinion shaft axes/central points span, in this case, a trapezoid. In the case of previous corresponding housings with (fourth) plug-in pinion shaft, the corresponding polygon stands on one corner and is of correspondingly tall construction. The parting-joint offsets in the parting joint in the divisible housing have the effect that the trapezoid in that case can be arranged flat on the long side, resulting in a flat structural space.

In a particular refinement, the divisible housing is part of a multi-stage geared compressor installation which has eight stages (four pinion shafts) with radial impellers and spiral housings. The sealing of the compressor stages with respect to the divisible (gearing) housing can be realized using Kohler rings. An electric motor may serve as a drive for the geared compressor installation.

Here, the divisible housing has a lower case, an upper case and a cover. The upper case and the lower case are connected by means of the “doubly stepped” parting joint (first or lower parting joint) which is sealed off by means of the sealing elements or by means of the sealing bars, that is to say complementary, two parting-joint offsets (in an upturned U-shaped profile), which are in the form of steps with identical step height and are sealed off by means of the sealing bars, in the parting joint. The cover and the upper case are connected by means of a further, undivided and horizontal parting joint (second or upper parting joint).

Both in the doubly stepped parting joint and in the undivided and horizontal further parting joint, there are arranged in each case two pinion shafts, which are equipped, on the free shaft ends, with turbo impellers.

Furthermore, the shaft of the large gear is arranged in the doubly stepped parting joint and between the two pinion shafts arranged there.

Through incorporation of the parting-joint offsets or steps in the first/lower parting joint, the condition that the pinion shafts and the large-gear shaft must lie in one plane is eliminated. It is thus possible for the pinion shafts of the first parting joint to migrate downward (upturned U-shaped profile) and for structural space to thus be realized in the second/upper parting joint. Said structural space in the second/upper parting joint is utilized for receiving a/the second pinion shaft (instead of some other plug-in pinion shaft), whereby a cumbersome plug-in pinion shaft arrangement is omitted.

Here, it is however also possible for the second/upper parting joint to be formed with a parting-joint offset (e.g. stepped second/upper parting joint), whereby, here, the two pinion shafts of the or in the second/upper parting joints would lie in different planes or at different levels.

The above description of advantageous embodiments of the invention contains numerous features which, in the individual subclaims, have in part been reproduced severally in combination. A person skilled in the art will however expediently also consider said features individually and combine them to form further meaningful combinations.

The above-described characteristics, features and advantages of this invention, and the manner in which these are achieved, will become clearer and more easily understandable in conjunction with the following description of one or more exemplary embodiments which will be discussed in more detail in conjunction with the figures.

The invention is however not restricted to the combination of features specified in the exemplary embodiment(s), and also not with regard to functional features. For this purpose, it is possible for suitable features of each exemplary embodiment also to be explicitly considered in isolation, removed from an exemplary embodiment and introduced into another exemplary embodiment in order to enhance the latter.

Elements or components which are of similar function/type of construction or identical have the same reference designations in the exemplary embodiments and figures.

### BRIEF DESCRIPTION OF THE DRAWINGS

In the figures:

FIG. 1 shows a view (front view) of a divided housing, which has a cover, an upper case and a lower case, for a gearing of a multi-stage geared compressor,

FIG. 2 shows a sketch illustrating the shaft arrangement in the case of the divided housing for a gearing of a multi-stage geared compressor from FIG. 1,

FIG. 3 is a three-dimensional illustration of the divided housing, which has a cover, an upper case and a lower case, for a gearing of a multi-stage geared compressor as per FIG. 1,

FIG. 4 shows a view (rear view) of a sealing bar for sealing off a parting-joint offset in the case of the parting joint between the lower case and the upper case of the divided housing for a gearing of a multi-stage geared compressor as per FIGS. 1 to 3,

FIG. 5 shows a view (sectional side view; section line A-A) of a sealing bar for sealing off a parting-joint offset in the case of the parting joint between the lower case and the upper case of the divided housing for a gearing of a multi-stage geared compressor as per FIGS. 1 to 3,

FIG. 6 shows a view (front view) of a sealing bar for sealing off a parting-joint offset in the case of the parting joint between the lower case and the upper case of the divided housing for a gearing of a multi-stage geared compressor as per FIGS. 1 to 3,

FIG. 7 shows a sectional view (section line B-B as per FIG. 4) of a sealing bar for sealing off a parting joint offset in the case of the parting joint between the lower case and the upper case of the divided housing for a gearing of a multi-stage geared compressor as per FIGS. 1 to 3, and

FIG. 8 shows a detail view (detail C as per FIG. 5) of a sealing bar for sealing off a parting joint offset in the case of the parting joint between the lower case and the upper case of the divided housing for a gearing of a multi-stage geared compressor as per FIGS. 1 to 3.

### DETAILED DESCRIPTION OF INVENTION

Exemplary embodiment: doubly stepped first parting joint in the case of a divided gearing housing for a gearing of a multi-stage geared compressor with parting-joint offsets sealed off by means of sealing bars

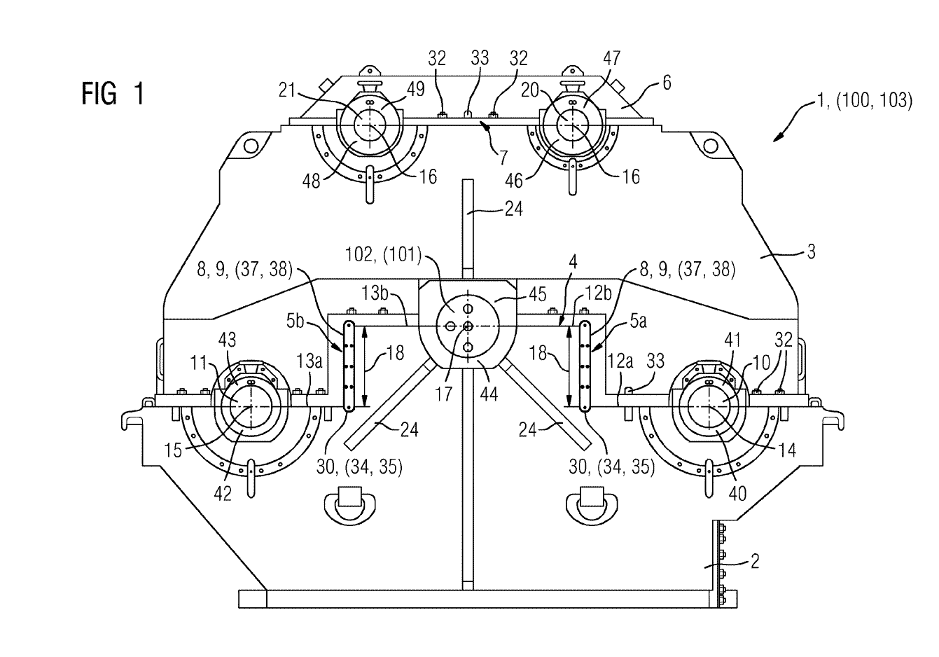

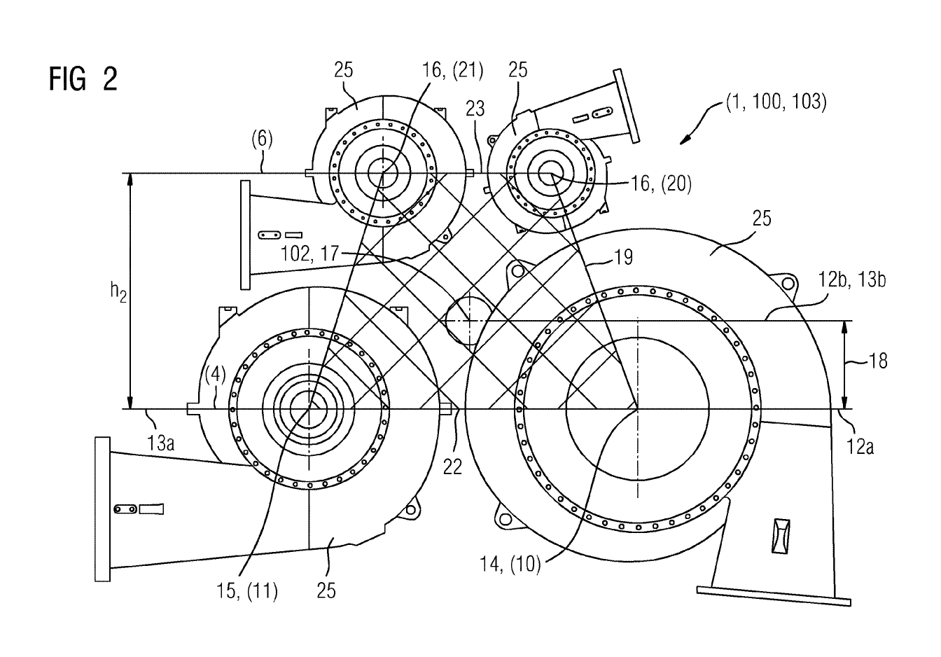

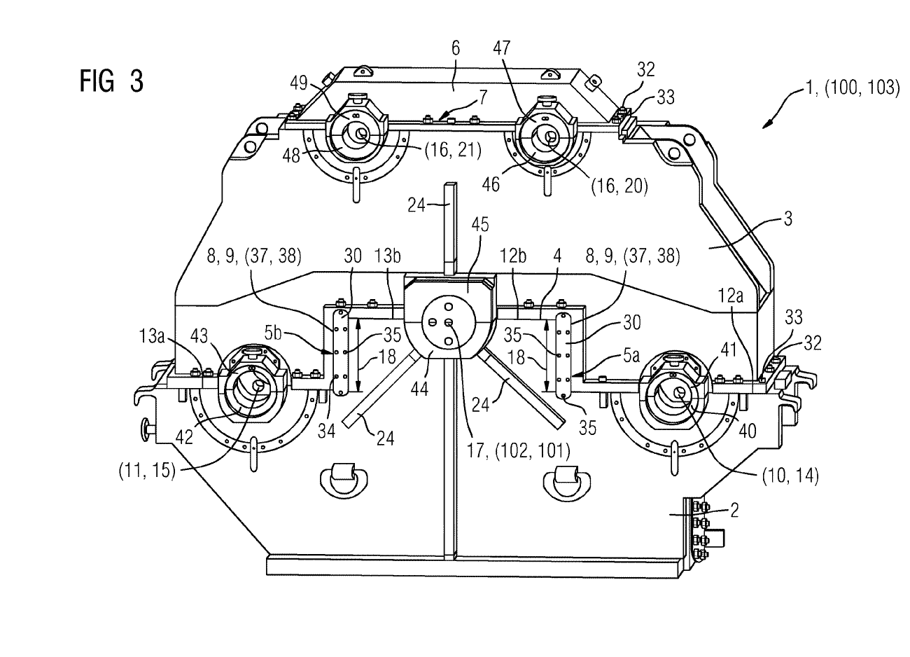

FIGS. 1 and 3 (front and three-dimensional view) and FIG. 2 (shaft arrangement) show views of a divided housing 1 (gearing housing) with lower case 2, upper case 3 and cover 6 for a gearing 100 of a multi-stage geared compressor which is provided for air separation.

The divided housing 1 has the illustrated lower case 2, the illustrated upper case 2 arranged over or above the lower case 2, and the illustrated cover 6 arranged over or above the upper case 3—all of these advantageously being composed of steel.

The lower case 2 and the upper case 3 are connected to one another via a first, doubly stepped, horizontal parting joint 4; the upper case 3 and the cover 6 are connected to one another via a second, horizontal and non-stepped parting joint 7.

The multi-stage geared compressor is composed of eight (compressor) stages (A to H) which are realized by means of a gearing 100 which is received in the divided housing 1 and which has four pinion shafts A/B 10, C/D 11, E/F 20, G/H 21 of the gearing 100, which are in engagement with a large gear 101, arranged on a large-gear shaft 102, of the gearing 100. On the free ends of the four pinion shafts A/B 10, C/D 11, E/F 20, G/H 21 there are arranged turbo impellers which, as shown in FIG. 2, are received in spiral housings 25 (flow-guiding components) which are arranged externally with respect to the gearing housing 1.

All four pinion shafts A/B 10, C/D 11, E/F 20, G/H 21 are arranged around a large gear 101 or large-gear shaft 102 and are in engagement, by means of toothings, with the large gear 101.

Here, the first A/B 10 and the second pinion shaft B/C 11 (stages 1 to 4)—in the first, doubly stepped, horizontal parting joint 4—are arranged to both sides of the large gear 101 or of the large-gear shaft 102; the third E/F 10 and the fourth pinion shaft G/H 21 (stages 5 to 8)—in the second, horizontal and non-stepped parting joint 7—are arranged above the large gear 101 or the large-gear shaft 102.

To permit efficient engagement of the pinion shafts A/B 10, C/D 11, E/F 20, G/H 21, the pinion shafts A/B 10, C/D 11, E/F 20, G/H 21 are—with regard to their spacing to the large-gear shaft 102—arranged such that the pitch circles of the pinion shafts A/B 10, C/D 11, E/F 20, G/H 21 each contact the pitch circle of the large gear 101.

The large gear 101 or the large-gear shaft 102 is driven by means of an electric motor (not illustrated). The sealing of the compressor stages with respect to the gearing housing 1 is realized by means of Kohler rings.

As shown in FIGS. 1 and 3, the lower case 2, on its bottom side which together with the top side of the upper case 3 forms the first, doubly stepped second, horizontal parting joint 4, has receptacles 44, 45, that is to say the shaft seats 44, 45, for the shaft 102 of the large gear 101 (axis of rotation of the large-gear shaft or large-gear shaft central position 17) and the first A/B 10 (arranged to the right of the large-gear shaft 102 in the front view) and the second pinion shaft C/D 11 (arranged to the left of the large-gear shaft 102 in the front view) (axes of rotation 14, 15 of the pinion shafts 10, 11).

As shown in FIGS. 1 and 2, the first, doubly stepped parting joint 4 has two complementary offset points 5a of equal height (right-hand step arranged to the right of the large-gear shaft 102 in the front view), (left-hand step arranged to the left of the large-gear shaft 102 in the front view) 5b (“doubly stepped”) with in each case a height of approximately 400 mm.

Said step-like offset points 5a, 5b are formed in each case by corresponding steps 8 both in the lower case 2 of the housing 1 or on the top side thereof and also correspondingly in the upper case 3 of the housing 1 or on the bottom side thereof.

If it is the case here, as illustrated in FIGS. 1 to 3, that the parting-joint offsets 5a, 5b or the steps 8 are of complementary form—in this case specifically in an upturned U-shaped profile—then it is the case as a result that the pinion shaft receptacles 40, 41, 42, 43 (and thus also the pinion shafts A/B 10, C/D 11 or the pinion shaft central points/positions 14, 15 thereof) migrate downward in the first, doubly stepped, horizontal parting joint 4 (with respect to the large-gear shaft receptacle 44, 45 or the large-gear shaft 102 or shaft central point/position), whereby structural space is thus obtained in the second, horizontal and non-stepped parting joint 7.

That is also to say that, as illustrated in FIGS. 1 to 3, the first A/B 10 and the second pinion shaft C/D 11 lie no longer in the same horizontal plane 12b or 13b as the large-gear shaft 102, but rather—correspondingly to the parting-joint offsets 5a, 5b or step 8 that are formed—in lower horizontal planes 12a and 13a or at lower heights 12a, 13a. It is now only the case that the pitch circles of first A/B 10 and second pinion shaft C/D 11 and large gear 101 make contact.

If the first A/B 10 and the second pinion shaft C/D 11 (duly) lie below the large-gear shaft 102 but jointly in the first, doubly stepped, horizontal parting joint 4, this is expedient from an assembly and cost aspect.

To permit alignment of lower case 2 and upper case 3, the vertical step surfaces 9 are staggered with respect to one another. The lower case 2 and upper case 3 are, as shown in FIGS. 1 and 3, pinned 33 by means of centering pins and screwed 32. The upper case 3 and the cover 6 are also pinned 33 and screwed 32 as shown in FIG. 3.

As is also shown in FIGS. 1 and 3, the upper case 3, on its top side—which together with the bottom side of the cover 6 forms the second, horizontal and non-stepped parting joint 7—has the receptacles 46, 48, that is to say the shaft/bearing seats 46, 48 for the third E/F 20 (arranged on the right in the front view) and the fourth pinion shaft G/H 21 (arranged on the left in the front view). The corresponding receptacles 47, 49 or shaft/bearing seats 47, 49 for the third E/F 20 and the fourth pinion shaft G/H 21 are also provided in the bottom side of the cover 6.

Here, both of the two pinion shafts 20, 21 lie in a (common) horizontal plane—as per the second, non-stepped and horizontal parting joint 7.

If, as is possible here, it is sought for not only the third pinion shaft E/F 20 but also the fourth pinion shaft G/H 21 to be received in the second, horizontal and non-stepped parting joint 7, it is possible for a fourth pinion shaft which must otherwise be provided as a plug-in pinion shaft (as a cumbersome plug-in pinion shaft arrangement) to be omitted.

If the third E/F 20 and the fourth pinion shaft G/H 21 lie jointly in the second, horizontal and non-stepped parting joint 7, this is expedient from an assembly and cost aspect inter alia owing to the improved accessibility.

As illustrated in FIG. 2, the pinion shafts A/B 10, C/D 11, E/F 20, G/H 21 or the receptacles 40 to 43, 46 to 49 thereof or the pinion shaft central positions 14, 15, 16 (axis central points) thereof span a trapezoid 19, the two horizontally oriented base sides 22, 23 of which are formed by the pinion shafts A/B 10 and C/D 11 or the receptacles 40 to 43 thereof or the pinion shaft central positions 14, 15 thereof and by the pinion shafts E/F 20 and G/H 21 or the receptacles 46 to 49 thereof or the pinion shaft central positions 16 (axis central points) thereof.

That is to say, the trapezoid 19 “lies flat” on one of its base sides 22, 23 (“height” of the trapezoid h2), resulting in the flat structural space. In the case of corresponding housings with a plug-in pinion arrangement, the corresponding polygon (through the shaft central points/receptacles) stands on one corner and is of correspondingly tall construction.

A weakening of the housing 1 or of the gearing cases 2, 3 is compensated for by stiffening means 24 arranged in stellate fashion around the large-gear shaft receptacle 44, 45 on the gearing cases 2, 3.
Sealing of the first, doubly stepped, horizontal parting joint 4 by means of (two) sealing bars 30 with O-ring 31 (FIGS. 1, 2 and 4 to 8).

The lubrication of the gearing 100 arranged in the housing 1 is realized by means of oil sump lubrication, wherein the oil sealing of the first, doubly stepped parting joint 4, in particular of the two parting-joint offsets 5a, 5b there or of the steps 8 in the lower case 2 and the upper case 3, is of central importance.

For this purpose, as shown in particular in FIG. 1, FIG. 3 and FIGS. 4 to 8, the gearing housing 1 provides the use of two sealing elements 30, that is to say two sealing bars 30, which are identical (in this case owing to the identical/complementary form of the two parting-joint offsets 5a, 5b or steps 8).

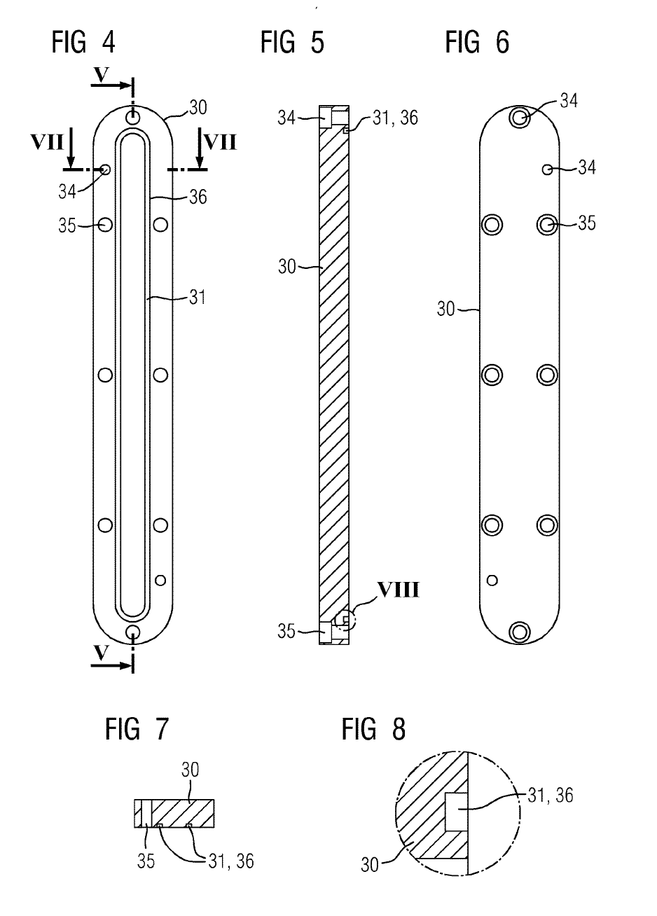

As shown in FIGS. 1 and 3 and in particular FIGS. 4 to 8, the sealing bar 30 is in each case a rod-shaped component, in this case of a length of approximately 450 mm and a width of approximately 70 mm, which corresponds to the shape of the first or second or respective parting-joint offset 5a, 5b or which corresponds in terms of its outer diameter to the shape of the first or second or respective parting-joint offset 5a, 5b.

As shown in FIGS. 4 and 6, the sealing bar 30 has, in encircling ring-shaped fashion at its edges, screw seats 34, 35 by means of which said sealing bar is screwed 32 to the lower case 2 and to the upper case 3.

As shown in FIGS. 4 and 5, for the sealing of the respective parting-joint offset 5a, 5b, there is laid onto the sealing bar 30 a sealing means 31, that is to say in this case an O-ring (which realizes the sealing action) is laid into a groove on the sealing bar 30 or on the inner side thereof.

As shown in particular in FIGS. 1 and 3, said sealing bars 30—in each case with the O-ring 31 laid in the groove 36—are screwed 32 over the respective parting-joint offset 5a or 5b in recessed fashion from the outside, wherein said sealing bar completely covers the respective parting-joint step 5a or 5b.

For this purpose, as shown in FIGS. 1 and 3, for each sealing bar 30, on the housing elements 2, 3 or on the lower case 2 and on the upper case 3, there are arranged receptacles 37 (on the lower case 2) and 38 (on the upper case 3), that is to say a sealing-bar seat 37 (on the lower case 2) and a sealing-bar seat 38 (on the upper case 3), in the form of axial recesses 37, 38 on the lower case 2 and on the upper case 3, on which the respective sealing bar 30 lies (by means of its edge regions), as shown or illustrated in particular in FIGS. 1 and 2.

The production of the recessed sealing-bar seats or sealing-bar seats 37, 38 on the gearing housing 1 or on the lower case 2 and on the upper case 3 is performed during the spindling-out of the receptacles 40, 41, 42, 43 or bearing seats 40, 41, 42, 43 of the first A/B 10 and second C/D pinion shaft 11, and does not necessitate any further machining steps.

Owing to its rod-shaped or bar-shaped form which is adapted to the respective parting-joint offset 5a or 5b and (and which is of horizontally compact construction in the case of a vertical arrangement) and the (thereby also permitted completely) recessed arrangement of the respective sealing bar 30 on the housing elements 2, 3, said sealing bar does not pose an obstruction to adjacent (flow-guiding) components; the spiral housing 25 and the device for spiral setting can still be mounted, but the sealing bar 30 is of extremely compact construction in the horizontal direction, whereby the structural space requirement or a structural space limitation/obstruction in said direction is as small/minor as possible.

Then, if the O-ring 31 of the respective sealing bar 30 lies axially in the respective axial sealing-bar seats 37, 38 or axial recesses 37, 38 formed on the housing elements 2, 3 or on the lower case 2 and on the upper case 3 in the region of the respective parting-joint offset 5a or 5b, or is screwed 32 axially to the housing elements 2, 3 or to the lower case 2 and to the upper case 3, the sealing bars 30 thus in this case have an axial sealing action, whereby it is possible to dispense with a fit for the centering of the sealing bars 30 in the housing elements 2, 3.

Said sealing bars 30 with said O-rings 31 (lying axially thereon) furthermore have the advantage that the sealing direction acts counter to the clamping force of the part screw connection. Also, regardless of the sealing means arrangement, that is to say the arrangements of the O-ring 31, on the sealing bar 30, the design and assembly of the parting-joint screw connection/pin connection 32, 33 remain unaffected.

Even though the invention has been illustrated and described in more detail on the basis of the one or more preferred exemplary embodiments, the invention is not restricted by the disclosed examples, and other variations may be derived from these by a person skilled in the art without departing from the scope of protection of the invention.

1. A divisible housing for a gearing which can be received in the divisible housing of a gearing of a fluid machine, having a large-gear shaft and having at least two pinion shafts which mesh with a large gear arranged on the large-gear shaft, wherein the divisible housing comprises:
at least one first housing element and one second housing element which is connected to the first housing element via a parting joint, and the large-gear shaft and the at least two pinion shafts can be received in receptacles on the housing element in the parting joint,
wherein the parting joint has a first parting-joint offset and a second parting-joint offset, which form in each case two different horizontal levels in the parting joint and which are arranged in each case between two of the receptacles of two of the shafts and which are of complementary form with respect to one another.

2. The divisible housing as claimed in claim 1,
wherein the first and the second housing element have in each case one mutually corresponding step which forms one of the parting-joint offsets.

3. The divisible housing as claimed in claim 1,
wherein the receptacles for the two pinion shafts are arranged to both sides of the receptacle for the large-gear shaft on the housing elements in the parting joint.

4. The divisible housing as claimed in claim 1,
wherein a height difference, formed by one of the parting-joint offsets, of the two different horizontal levels is defined in a manner dependent on dimensions of the shafts and/or pinions arranged on the shafts and/or in a manner dependent on a structural space requirement.

5. The divisible housing as claimed in claim 1,
wherein the first and/or the second parting-joint offset is sealed off using/in each case using a sealing element which has a form substantially corresponding to the respective parting-joint offset.

6. The divisible housing as claimed in claim 1,
wherein the sealing element is a sealing bar and/or in that the sealing element is composed of metal.

7. The divisible housing as claimed in claim 5,
wherein the sealing element is arranged over the parting-joint offset, and/or recessed in the parting-joint offset.

8. The divisible housing as claimed in claim 5, further comprising:
a sealing device or an O-ring arranged on the sealing element, wherein, the sealing device or the O-ring lies axially in axial receptacles which are formed on the housing elements in the region of the parting-joint offset.

9. The divisible housing as claimed in claim 8,
wherein the sealing element has a groove or a projection in which or on which the sealing device is arranged, or into which the O-ring is laid or onto which the O-ring is mounted.

10. The divisible housing as claimed in claim 1,
wherein the first and the second housing element are a lower case and an upper case of the gearing housing, and/or in that the first and the second housing element are oriented and/or centered relative to one another by means of vertically mutually staggered step surfaces of steps which form the parting-joint offsets, and/or in that the first and the second housing element are pinned to one another and/or are screwed to one another.

11. The divisible housing as claimed in claim 10,
wherein the divisible housing has a third housing element which is connected to the first housing element or to the second housing element via a further parting join.,

12. The divisible housing as claimed in claim 11,
wherein the gearing has at least two further pinion shafts which mesh with the large gear or with a further large gear.

13. The divisible housing as claimed in claim 12,
wherein the parting-joint offsets are formed in the parting joint, and the further parting joint is formed as a further, non-offset parting joint, such that the receptacles, arranged on the housing elements in the parting joints, of the at least two and of the at least two further pinion shafts form a trapezoid.

14. A fluid machine, turbine, turbocompressor, multi-stage geared compressor or pump, comprising:
the divisible housing as claimed in claim 1, and
a gearing which is received in the divisible housing and which has a large-gear shaft and at least two pinion shafts which mesh with a large gear arranged on the large-gear shaft,
wherein the at least two pinion shafts and the large-gear shaft are received in the receptacles on the housing elements in the parting joint.

15. The divisible housing as claimed in claim 2,
wherein the first and the second housing element have two mutually corresponding steps which form the parting-joint offsets.

16. The divisible housing as claimed in claim 6,
wherein the metal comprises aluminum.

17. The divisible housing as claimed in claim 7,
wherein the sealing element is arranged over the parting-joint offset in a manner screwed to the housing elements and/or recessed in the parting-joint offset so as to completely cover the parting-joint offset.

18. The divisible housing as claimed in claim 11,
wherein the further parting joint comprises a non-offset parting joint, and
wherein the third housing element is a cover, the first housing element is a lower case and the second housing element is an upper case of the divisible housing, wherein the third housing element is connected to the second housing element via the further non-offset parting joint.

19. The divisible housing as claimed in claim 12,
wherein the at least two further pinion shafts are arranged in receptacles on the second and third housing elements in the further parting joint which comprises a non-offset parting joint.

20. The divisible housing as claimed in claim 13,
wherein the receptacles of the at least two pinion shafts and the receptacles of the at least two further pinion shafts form in each case base sides of the trapezoid.
